(19) United States
(12) Patent Application Publication
(10) Pub. No.: US 2010/0153284 A1
(43) Pub. Date: Jun. 17, 2010

(54) METHODS AND SYSTEMS TO USE AN AGGREGATED CONTACT LIST FOR SHARING ONLINE INFORMATION

(75) Inventors: Andrew J. Hoag, San Francisco, CA (US); Elisha J. Fitch-Cook, Mulliken, MI (US)

Correspondence Address: PERKINS COIE LLP, P.O. BOX 1208, SEATTLE, WA, 98111-1208, US

(73) Assignee: Black Drumm, Inc., San Francisco, CA (US)

(21) Appl. No.: 12/337,373

(22) Filed: Dec. 17, 2008

(51) Int. Cl. G06Q 99/00; G06Q 30/00

(52) U.S. Cl. 705/319; 705/26; 715/753; 705/14.5

(57) ABSTRACT

The present invention provides methods and systems for using an aggregated contact list for sharing online information. In one embodiment, an event forum is provided with a connection link to enable a user to retrieve contacts from one or more online social or messaging networks. Upon the user providing authentication credentials to login to the one or more online social or messaging networks, an aggregating service retrieves the user's contacts from each of the networks. In one embodiment, the contacts from all the networks are presented as an aggregated list, allowing the user to select one or more contacts to send a message related to the event forum. In one embodiment, the aggregating service creates a landing web page specific to the message transmitted by the user. In some instances, the landing web page enables the user and the contacts to exchange messages.

### FIELD OF INVENTION

The present invention generally relates to the field of online social networks. More particularly, the present invention relates to methods and systems for using an aggregated contact list collected from various online social or messaging networks for sharing online information.

### BACKGROUND OF THE INVENTION

With the rapid increase and advances in internet technology, the world wide web (hereinafter the “web” or the “internet”) has become a ubiquitous source of disseminating information. For example, the web is widely used to post and advertise information about events (e.g., concerts, public gatherings, etc.). Owing to the enormous corpus of information available on the web, it is becoming increasingly difficult to keep up with the growing number of web sites and social web communities. Consequently, it is difficult for users to share information about the event with their friends and other contacts.

Most web sites, especially web sites that host information about events, gatherings, etc., (herein after “event forums”) allow users to share such information with other people. In some instances, the web sites allow the user to enter one or more electronic mail addresses of their contacts. The web sites transmit a message about the event to the specified electronic mail addresses along with a personal message from the user. However, these web sites require the user to manually enter the electronic mail address of each contact they wish to share the event with, making it a cumbersome task.

Online social networks are increasingly becoming a source for web users to maintain a database of contacts. Web users are constantly posting and sharing information to their contacts through the online social networks. Examples of online social networks include Twitter®, Facebook®, MySpace®, etc. Additionally, web users use a variety of messaging networks to maintain databases of contacts. Examples of messaging networks include Gmail®, Yahoo! Mail®, AIM®, text and picture messaging, instant messaging, etc. It would therefore be beneficial for the user to access the database of contacts from such networks to share events and other information with their contacts.

Prior art solutions take advantage of the online social or messaging networks to share information. These solutions place a source (e.g., a hyper linked text or an HTML button) in the event forum to allow the user to share information about the event forum. By clicking on the source, the user is directed to the web site of an online social or messaging network. The user is then able to supply his credentials to that particular online social or messaging network and subsequently pull up a database of contacts within the web site of the online social or messaging network. By selecting contacts from the online social or messaging network, the user is ultimately able to send information about the forum page without having to type in electronic mail addresses.

However, the above prior art solutions suffer several disadvantages. First, the user is taken to a separate web page each time he wishes to share an event using a particular online social or messaging network, diverting the user away from the event forum.

Second, with the increasing popularity of online social and messaging networks, a user maintains accounts with more than one online social or messaging network. For example, the user may maintain an account with a first online social or messaging network for his personal contacts, and another account with a second online social or messaging network for his business contacts. In such cases, when using the prior art solutions, the user would have to separately log-in to web sites of each of his online social or messaging networks to share information with multiple sets of contacts.

Additionally, a user's contact list from one online social or messaging network may have at least some overlap with the user's contact list from another online social or messaging network. Therefore, the user may not be aware that he is sending duplicate messages to the same user, or it may be cumbersome for the user to identify repeated contacts to avoid sending duplicate messages.

### SUMMARY OF THE INVENTION

Methods and systems for using an aggregated contact list for sharing online information are provided. In one embodiment, an event forum includes a connection link (e.g., an HTML button, a hyper-link text, etc.) allowing a user to initiate sharing information about the event forum. Upon clicking on the connection link, the user is presented with a list of online social or messaging networks (e.g., Facebook®, MySpace®, Gmail®, Yahoo! Mail®, etc.). In some instances, the user provides authentication information to gain access to one or more of the online social or messaging networks.

In one embodiment, an aggregating service pulls contact information from the online social or messaging networks and displays an aggregated list of contacts (e.g., as a hovering window, a new window, etc.) in the event forum. In some instances, the aggregated contact list allows the user to add contacts from additional networks. The contacts are displayed based on a variety of categories to enable the user to easily choose the contacts he wishes to send a message to. In some instances, the aggregating service eliminates duplicate contacts appearing in more than one online social or messaging network. The user is subsequently provided a messaging window allowing the user to send information about the event forum to a selected list of contacts.

In one embodiment, the aggregating service creates a user specific landing web page in response to the message transmitted by the user. In some instances, the landing web page includes the aggregated contact list. Additionally, in some embodiments, the landing web page indicates a status of each of the contacts in the aggregated contact list based on a response from each of the contacts. In some instances, the landing web page includes information about the event and provides space for relevant advertising. In some instances, the landing web page includes a discussion forum allowing the users to post and exchange messages. In one embodiment, the user is provided additional options, such as including or removing additional contacts, sending additional messages to a selected list of contacts, etc.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1A depicts an embodiment of a social website that utilizes the centralized messaging technique using the aggregating service;

FIG. 1B illustrates an embodiment where the connection link is located within the toolbar of a browser application;

FIG. 2 illustrates an embodiment of the online social website displaying a list of social networks;

FIG. 3 illustrates an embodiment of the forum page where the user gains access to one or more online networks;

FIG. 4 depicts an embodiment of an aggregated list of contacts displayed within the forum page;

FIG. 5 illustrates an embodiment of the centralized list display where the user is allowed to include contacts from additional online networks;

FIG. 6 depicts one embodiment of an aggregated list showing the contacts listed in multiple categories;

FIG. 7 illustrates an embodiment of a means by which a centralized message is sent to multiple contacts from an aggregated list of contacts;

FIG. 8 depicts an example of a confirmation page displayed after a message is sent by the aggregating service;

FIG. 9 is an example of a landing page that is generated based on the message transmitted by the user;

FIG. 10 is one embodiment of a system that can be used to implement an aggregating service;

FIG. 11 is a flow chart illustrating a method to send a message to an aggregated list of contacts retrieved from one or more online networks;

FIG. 12 is a flow chart depicting an embodiment of displaying a landing page utilizing the aggregating service; and

FIG. 13 is a high-level block diagram showing an example of the architecture for a computer system.

### DETAILED DESCRIPTION OF THE INVENTION

The present invention may be embodied in several forms and manners. The description provided below and the drawings show exemplary embodiments of the invention. Those of skill in the art will appreciate that the invention may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

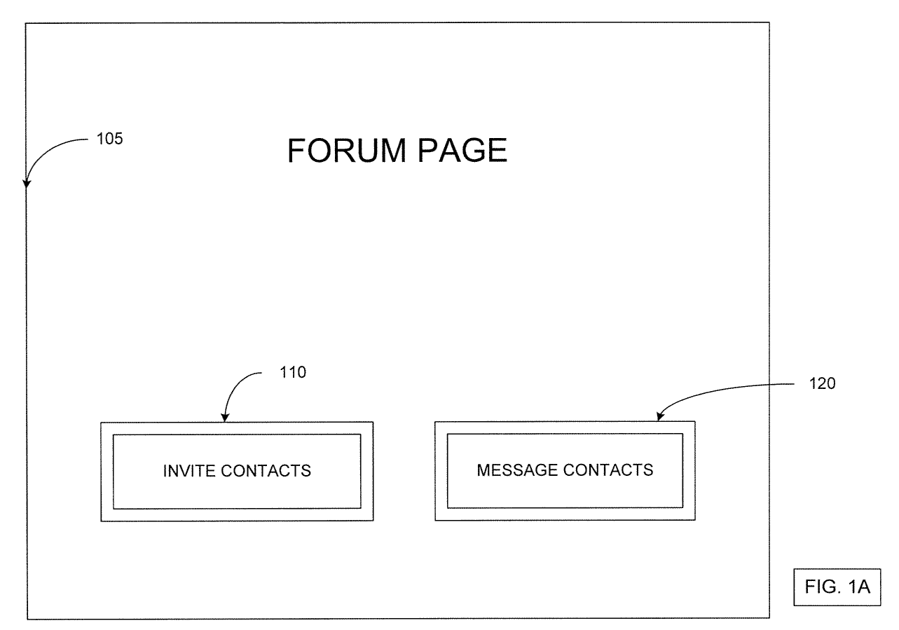

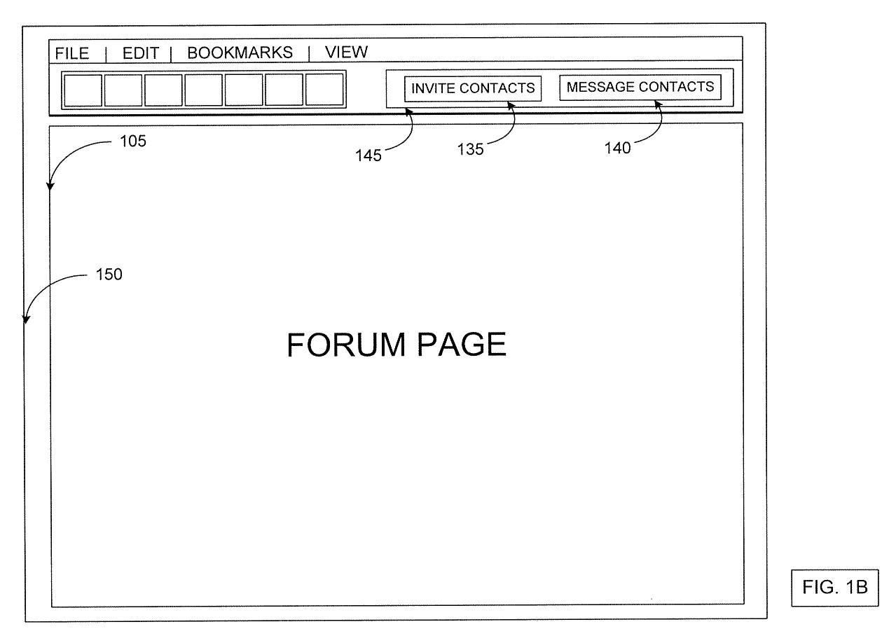

For purpose of illustration, it is useful to consider the techniques explained herein as applied to a social website. FIGS. 1 to 9, discussed below, illustrate such social website that utilizes centralized messaging techniques. Of course, however, it should be noted that the techniques introduced here apply to other websites as well.

FIG. 1A depicts an embodiment of a social website that utilizes the centralized messaging technique using the aggregating service. In one embodiment, a forum page 105 is a social website that displays information. In one embodiment, the forum page 105 is any online website that provides information within an browser application of a user's computer. In some instances, the forum page 105 is an online website that displays information about a social event. In other instances, the forum page 105 is an online website that displays one or more advertisements related to an event. In the context of the description here, an event includes a social activity, for example, a concert, an art show, etc.

The owner of the forum page (e.g., the organizer of the event) displays one or more connection links (e.g., 110, 120, etc.) on the forum page. The connection links (110, 120) enable the user to access the aggregated messaging capabilities discussed herein. In one embodiment, the forum page displays a graphic image 110 (e.g., a html button, a hyperlink image, etc.). This graphic image 110 indicates to the user that he would be able to retrieve an aggregated list of contacts by clicking on the graphic image 110. For example, the graphic image 110 specifies the text “Click here to invite your contacts” to enable the user to initiate retrieving an aggregated list of contacts.

In one embodiment, the owner of the forum page 105 includes the connection links (110, 120) within the content of the forum page. For example, the connection link (110, 120) is part of the original HTML code of the forum page. In other examples, the owner of the forum page 105 could include markup annotations (e.g., XML) within the forum page to allow the connection link (110, 120) to be displayed in a specific manner.

In another embodiment, as indicated in FIG. 1B, one or more of the connection links (e.g., 135, 140) may be located in, for example, the toolbar 145 of a browser application 150. Examples of browser applications include Microsoft Internet Explorer®, Mozilla Firefox®, etc. In some instances, a user may install such connection links within the toolbar. In other instances, the forum page 105 may provide the connection links and the user would then be able to drag the connection links to the toolbar 145. In other instances, the connection links may be incorporated (or dragged into) as a bookmark within the browser application 150. In such an embodiment, the owner of the forum page 105 does not include the connection links within the forum page 105. Instead, when a user clicks on the connection links that are already present in the toolbar 145 of the browser application 150.

It is noted that these examples for displaying the connection links are for illustration purposes only, and that other means by which external links can be included within the forum page 105 are equally applicable here. In one embodiment, the user initiates an aggregating service by clicking on the connection link in the forum page. For detailed description of an example of an aggregating service, refer to U.S. Provisional Patent Application No. ______, which is incorporate by reference herein.

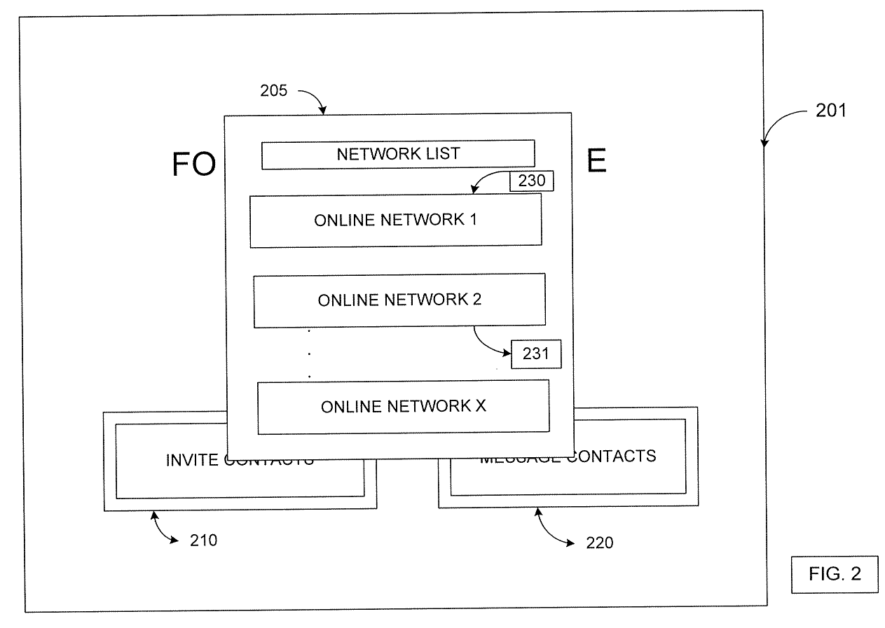

FIG. 2 illustrates an embodiment of the online social website 201 displaying a list of social networks 205. In one embodiment, a network list 205 is displayed when a user clicks on a connection link 210. The network list 205 includes a list of online networks (e.g., 230, 231). In some instances, the online network (e.g., 230) includes an online social network. Examples of such online social networks include Facebook®, Twitter®, MySpace®, LinkedIn®, etc. In other instances, the online network (e.g., 230) includes an online message network. Examples of such online message networks include electronic mail networks such as Gmail®, Yahoo! mail®, etc., or other communication networks such as AIM®, Yahoo! Messenger®, etc. It should be noted that these examples of online networks are for illustration, and that other forums that enable the user to engage in online communication with one or more people are also examples of online networks.

In one instance, the list of social networks 205 is presented within the forum page 201, for example, as a hovering window. In other instances, for example, when the user clicks on the connection link in a toolbar window (as explained in reference to FIG. 1B) to invoke the importation of contacts, the list of social networks 205 may be displayed in a separate window or a separate instance of the browser application. Other such embodiments as understood by a person of ordinary skill in the art, enabling the list of social networks to be displayed to the user, are considered equally applicable in this context.

In one embodiment, the user clicks on one of the online networks (e.g., 230) to import a list of contacts that he maintains in that particular online network. For example, the user clicks on online network 1 230 to import a list of contacts he maintains on the online network 1. Online network 1 230, as discussed above, is an online messaging or social network where the user maintains a database of contacts.

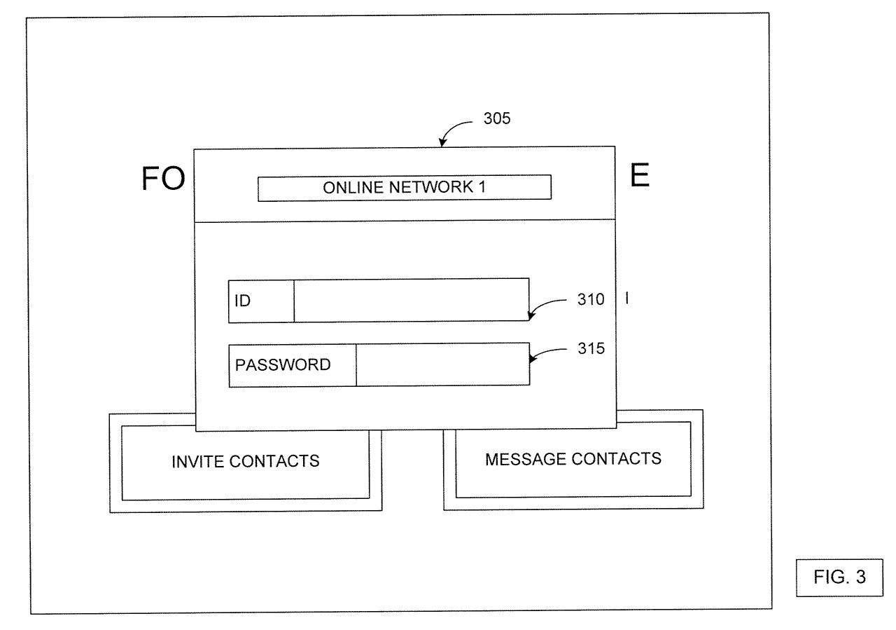

FIG. 3 illustrates an embodiment of the forum page where the user gains access to one or more online networks. When the user clicks on a particular online network (e.g., online network 1 230 of FIG. 2), he is directed to an authentication interface 305 for that particular online network. The user provides his authentication credentials (e.g., user identification 310 and password 315 pertinent to the particular online network) to gain access to the particular online network. In one embodiment, the user is directed to a homepage of the particular online network to enable the user to enter the authentication credentials. In another embodiment, a default interface (e.g., 305) appears for every online network that the user chooses. The default interface 305 collects the authentication credentials and supplies this information to the particular online network to establish access.

In one embodiment, each of the online networks includes a database of contacts. The database of contacts includes, for example, an address book within an online electronic mail account. In another example, the list of contacts could be the user's connections or “friends” within an online social network. In one embodiment, each entry within the database of contacts contains a contact's name, electronic mail address, the contact's profile photograph, etc. After the user verifies his identity by supplying his authentication credentials for a particular online network, the aggregating service described herein retrieves all contacts listed within the particular online network for eventual display in a centralized list.

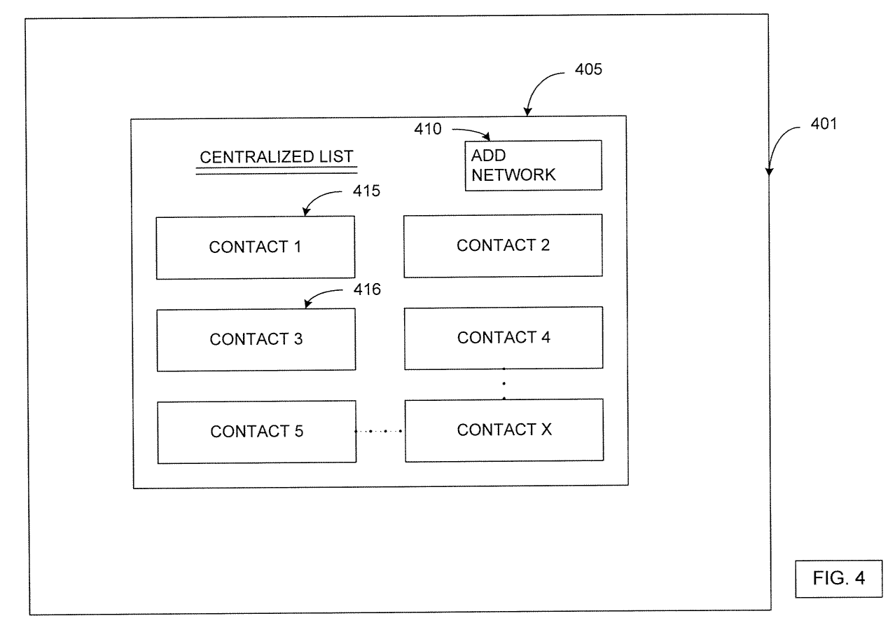

FIG. 4 depicts an embodiment of an aggregated list of contacts displayed within the forum page. In one embodiment, the aggregated list of contacts 405 is displayed as a hovering window within the forum page 401. In another embodiment, the centralized list 405 is displayed in a separate window. Other means known to people skilled in the art to display online information, for example through pop up windows, are equally applicable here.

In one embodiment, the aggregated list 405 contains a list of contacts (e.g., 415, 416) that have been retrieved from a particular online network. For example, if the user had previously supplied authentication information for online network A, then the aggregated list 405 displays all contacts that the user maintains within online network A. In some instances, the aggregated list 405 includes a provision 410 (e.g., a hyper-link) through which the user can add or aggregate contacts from additional online networks.

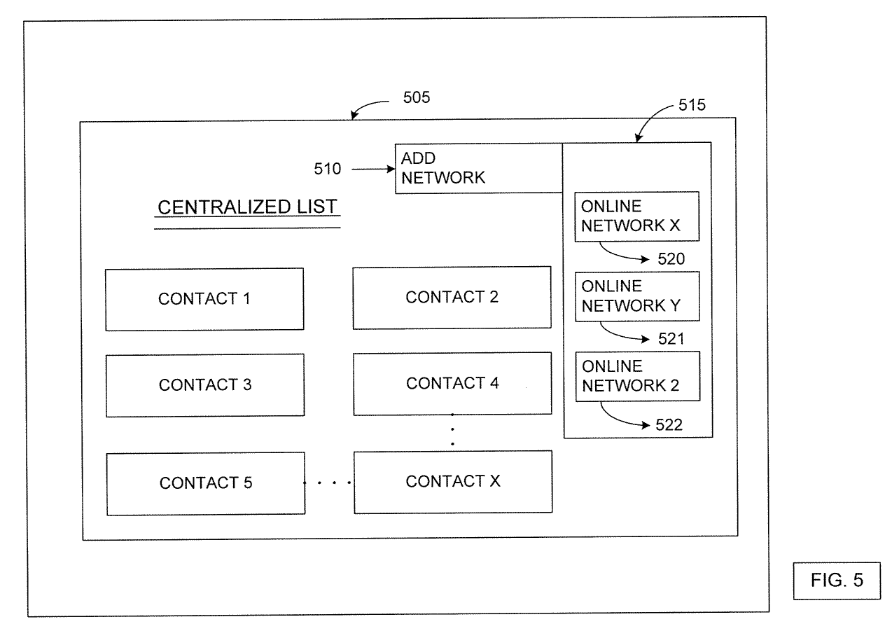

FIG. 5 illustrates an embodiment of the centralized list display where the user is allowed to include contacts from additional online networks. In some instances, the aggregated list 505 initially includes contacts from one particular online network. However, when the user clicks on, for example, the “add network” link 510, the aggregated list display further displays, for example, a sub-window 515 containing a list of additional online networks (e.g., 520, 521, 522). In one embodiment, the user clicks on one of the additional online networks (e.g., for example online network X 520) to include his list of contacts from online network X. In some instances, the aggregating service stores the authentication credentials provided by the user to each of the additional networks, and simply adds in contacts from the additional online networks as and when the user selects them from the sub-window 515. In other instances, the aggregating service collects authentication credentials from the user for each additional online network at the time the user elects to add the additional online network through the sub-window 515.

In one embodiment, when contacts are combined from more than one online network, the aggregating service eliminates duplicate contacts. In some instances, the aggregating service maps a particular contact from the database of contacts of one online network to another contact from the database of contacts of another online network. In one illustrative example, consider a name John Doe. If John Doe appears in the contact list of more than one online network (e.g., John Doe appears in the user's AIM® contact list and the user's Facebook® contact list), the aggregating service attempts to map the two names. The aggregating service then determines whether other information pertinent to John Doe (e.g., John Doe's email address, phone number, etc.) match between the information contained in the AIM® contact list and the Facebook® contact list. If the aggregating service determines that such a match exists, it eliminates the duplicate contact and lists only one contact information in the aggregated list 505.

In one embodiment, the aggregating service collects information from the user to determine whether a contact appears as a duplicate. In some instances, the user tags two contacts from the aggregated list 505 as a single contact. The aggregating service, for example, groups the two contacts and presents a single contact in the aggregated list 505 from then on.

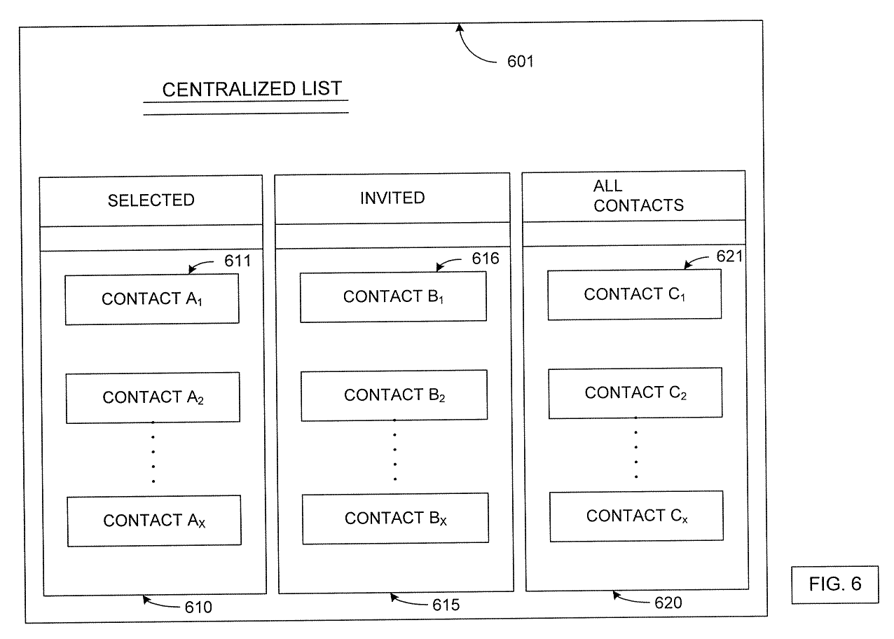

FIG. 6 depicts one embodiment of an aggregated list showing the contacts listed in multiple categories. In one embodiment, the aggregated list 601 displays the contacts based on multiple categories (e.g., 610, 615, 620). In some instances, contacts that are currently logged in and indicated as “online” in a particular online network is displayed in a separate category. In some instances, contacts that have already been invited to a particular event are displayed in a separate category (e.g., 615). In other instances, the contacts are displayed as a separate category (e.g., 620). In one embodiment, the various lists of categories are displayed as tabbed sections within the page 601 displaying the aggregated list.

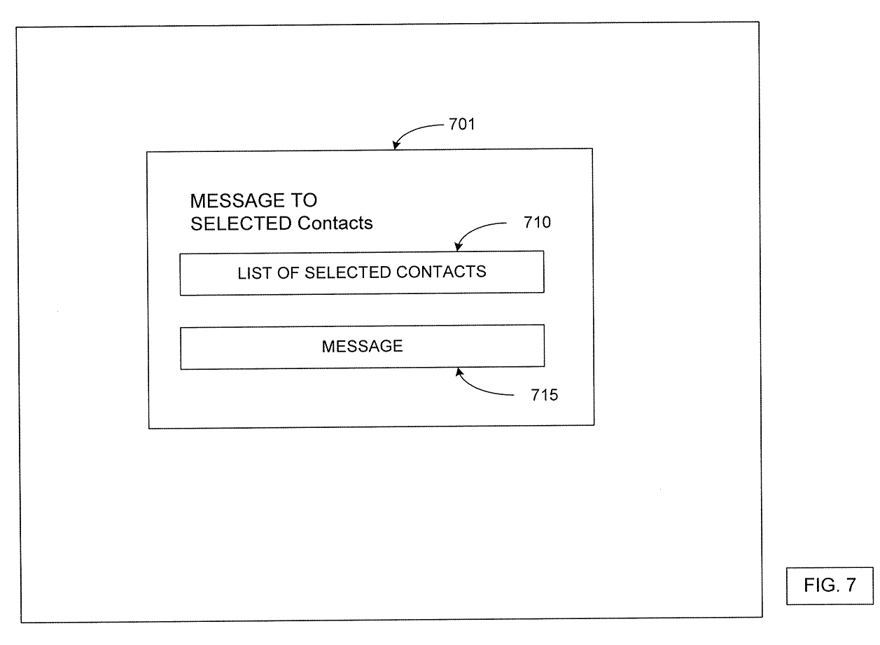

FIG. 7 illustrates an embodiment of a means by which a centralized message is sent to multiple contacts from an aggregated list of contacts. In one embodiment, the user selects one or more contacts to send a message. The message, in one example, could be an invitation to an event indicated in the forum page. When the user elects to send a message to a selected list of contacts, the aggregating service displays a messaging page 701 to the user. The message 715 in the messaging page 701 is addressed to the previously selected list of contacts 710. In some instances, the message is auto-filled with information specified by the forum page about the event. In other instances, the user includes a personal message before transmitting the image.

In some instances, each of the contacts may have multiple electronic mail addresses for transmission. When the message is transmitted to the contacts, the aggregating service, in some instances, sends a message to all known electronic mail addresses. In other instances, the aggregating service sends the message only to the contact's preferred electronic mail address. In some cases, the user may indicate that a particular electronic mail address is the preferred address to use for a particular contact regardless of the information retrieved from an online network. The aggregating service records such information for future messages to be sent to that particular contact.

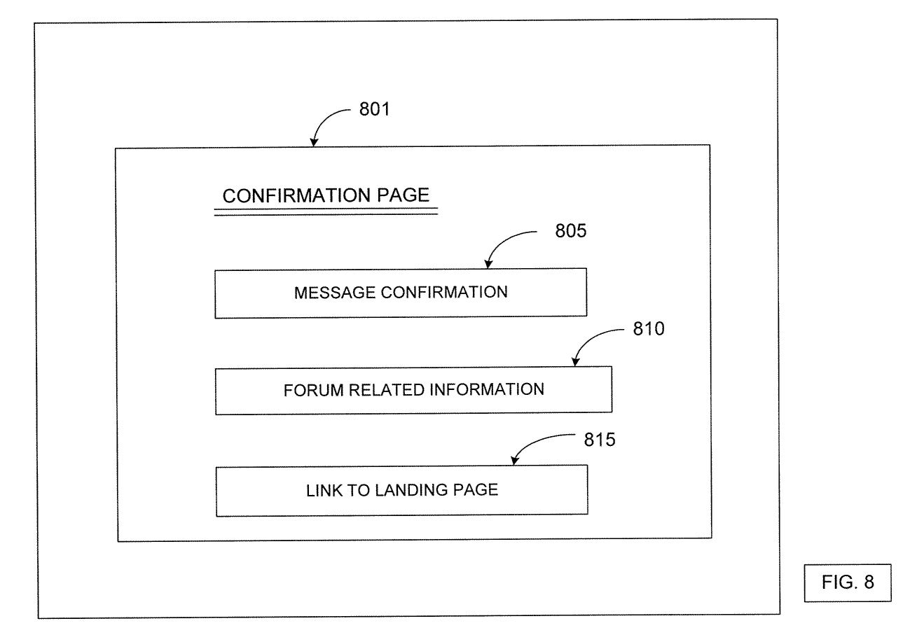

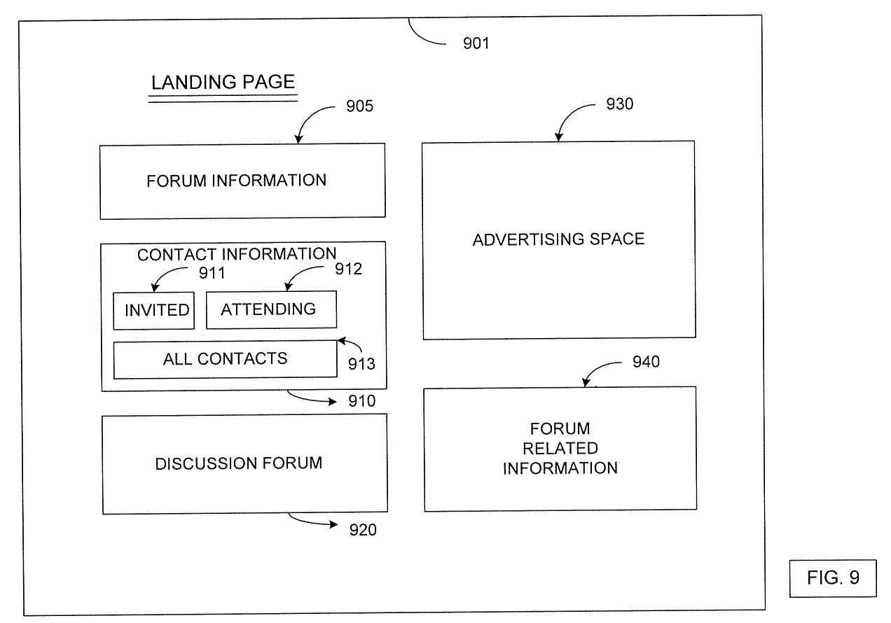

FIG. 8 depicts an example of a confirmation page displayed after a message is sent by the aggregating service. In one embodiment, the confirmation page 801 provides a message that the message was transmitted successfully 810. In some instances, the confirmation page 801 lists some information about either the forum page or about the event hosted by the forum page 810. In some instances, the confirmation page 801 may also include a link to a landing page 815. Detailed description of the landing page is provided below with reference to FIG. 9.

FIG. 9 is an example of a landing page that is generated based on the message transmitted by the user. In one embodiment, a separate landing page 901 is generated when the user transmits, for example, an invitation from an aggregated list of contacts. The landing page 901, in some instances, is accessible by the user and the contacts that received the message transmitted by the user. The landing page 901 includes information about the forum page and any events indicated in the forum page (e.g., 905).

The landing page also includes the aggregated list of contacts 910 that were previously retrieved by the aggregating service. In some instances, the contacts are listed based on multiple categories (e.g., 911, 912, 913). The categories include, for example, a list of contacts that were invited 911, a list of contacts that have indicated, for example, that they would be attending the event 912, a list of all contacts 913, etc. In some instances, the user or any of the contacts can include other contacts or send messages to existing list of contacts. In some instances, access to the contacts in the landing page 901 may be restricted only to the user for privacy reasons. In other instances, the contacts may be visible to other contacts, but the contacts' personal information may be hidden to the other contacts for privacy reasons.

In one embodiment, the landing page 901 includes a discussion forum 920 enabling the user and the contacts to post messages in the form of one or more discussion threads. Additionally, the landing page 901 also includes an advertising space 930 where, for example, advertisements related to the event or the forum page may be posted. In the context of the description here, advertisements include information related to the event, offers related to the event or related to the user's preferences, services (e.g., ticket sales, concierge services at the event, etc.) related to the event, etc.

In some instances, the landing page 901 includes a space where forum related information 940 is posted. The forum related information 940 includes, for example, weather forecast for the day of the event, information about the event's location, etc. It is to be noted that the landing page 901 as shown in FIG. 9 is for illustration only. Other embodiments of the landing page 901 may include variations to the format, content, or placement of the various sections discussed in FIG. 9.

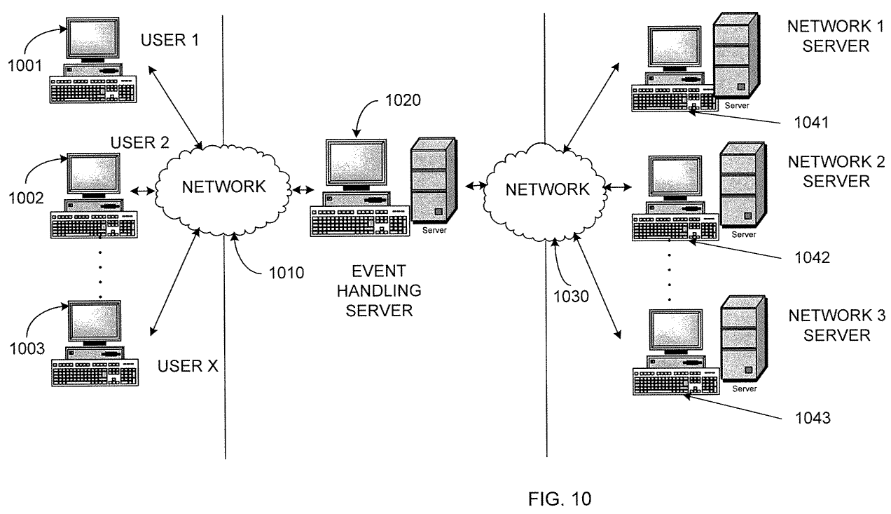

FIG. 10 is one embodiment of a system that can be used to implement an aggregating service. In one embodiment, a user uses one of the user computers (e.g., 1001, 1002, 1003) to access an aggregated list of contacts. In some instances, the user uses a browser application in a user computer 1001 to invoke the aggregating service from a particular forum page. Examples of a user computer (e.g., 1001) include a desktop computer, a laptop computer, a mobile device (e.g., a personal digital assistant, a mobile cellular telephone with internet access, etc.), etc. Other examples of user computers that enable a user to display a forum page and allow the user to access information over a network are equally applicable here.

When the user invokes the aggregating service, for example, by clicking on an “invite friends” button on the forum page, the browser application of the user computer 1001 transmits the request to an aggregating server 1020. The information is transmitted through a network 1010. The network 1010, in one embodiment is the public internet.

In response to a request from the user computer 1001, the aggregating server 1020, in one embodiment, responds by instructing the internet browser of the user computer 1001 to display a list of online networks. When the user selects one of the online networks, the aggregating server 1020, in some instances, collects authentication credentials from the user. The aggregating server 1020 transmits the authentication information to a server corresponding to the online network (e.g., 1041, 1042, 1043). The aggregating server 1020 transmits this information using the network 1030. The network 1030, in some embodiments is the public internet.

The server corresponding to the online network 1041 verifies the user credentials and provides the aggregating server 1020 with a list of contacts corresponding to the user's account with the online network. The aggregating server 1020 transmits this information to the user computer 1001 to be displayed in the browser application of the user computer 1001. Other configurations of the network and communication sequences, as understood by people skilled in the art, are possible to implement the described aggregating service for centralizing a list of contacts from several online networks.

In one embodiment, a mobile device (e.g., a mobile cellular telephone) may be used to take advantage of the techniques described herein. In some instances, the aggregating service may be included as a stand-alone application within a mobile device. In other instances, the aggregating service may be invoked using a browser application within the mobile device. In such instances, the aggregating service uses location finder services of the mobile device (e.g., GPS tracking, GPRS positioning, etc.) to identify the location of the user. In such an embodiment, the aggregating service may search for social events, other services, or suitable advertisements to display based on the identified location of the user.

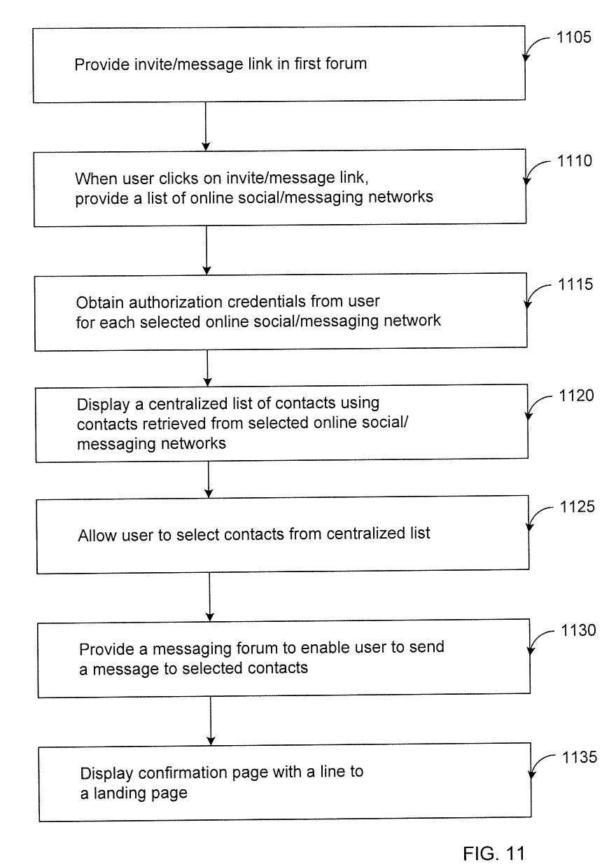

FIG. 11 is a flow chart illustrating a method to send a message to an aggregated list of contacts retrieved from one or more online networks. In one embodiment, a first forum page provides a link through which a user can send a message to a selected list of contacts 1105. When the user selects the link from the first forum, a list of online networks is displayed 1110. When the user selects one of the online networks, in some instances, the aggregating service collects the user's authentication credentials to enable the user to login to the selected online network 1115. Upon the online networks providing access, the aggregating service aggregates the contacts from the various online networks and provides an aggregated list of contacts, and provides the list to the user 1125. The user is then allowed to select one or more contacts from the aggregated list of contacts to send a message related to the event indicated in the first forum 1130. The aggregating service finally displays a confirmation page indicating that the message was sent to the selected contacts 1135.

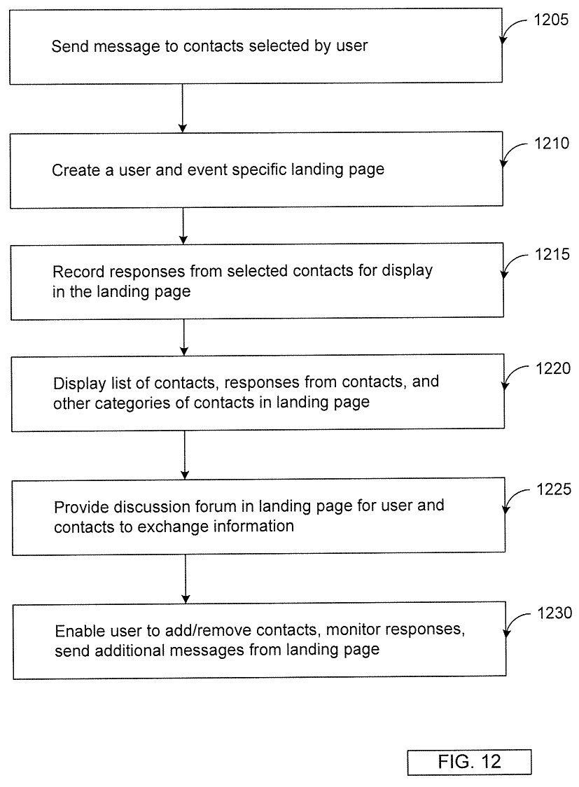

FIG. 12 is a flow chart depicting an embodiment of displaying a landing page utilizing the aggregating service. In one embodiment, a message is transmitted to a selected list of contacts 1205 using, for example, the method discussed in FIG. 11. The aggregating service, in some instances, generates a user and event specific landing page in response to the transmitted message 1210. In one embodiment, the aggregating service displays the list of aggregated contacts in the landing page. The aggregating service receives responses from the selected contacts and updates the information in the landing page 1220. In some embodiments, the landing page includes a discussion section to enable the user and the contacts to post/exchange information 1225. In some instances, the user is provided with a number of administrative rights, including removing or adding contacts to the centralized list, sending additional messages to selected contacts, etc. 1230.

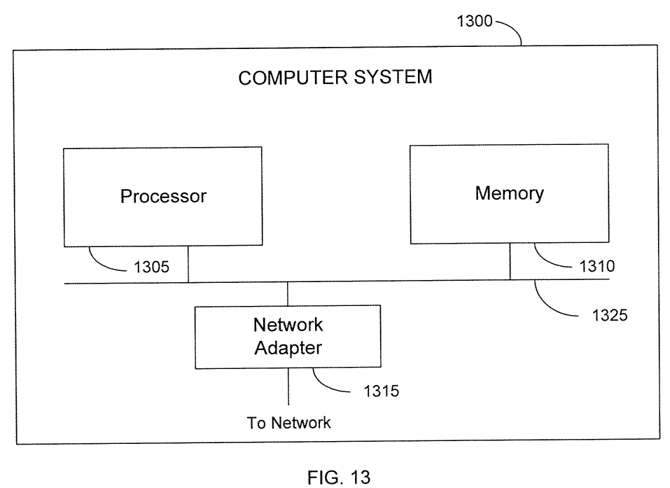

FIG. 13 is a high-level block diagram showing an example of the architecture for a computer system 1300 that can be utilized to implement a user computer (e.g., 1001 from FIG. 10), an aggregating server (e.g., 1020 from FIG. 10), etc. In FIG. 13, the computer system 1300 includes one or more processors 1305 and memory 1310 connected via an interconnect 1325. The interconnect 1325 is an abstraction that represents any one or more separate physical buses, point to point connections, or both connected by appropriate bridges, adapters, or controllers. The interconnect 1325, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”.

The processor(s) 1305 may include central processing units (CPUs) to control the overall operation of, for example, the host computer. In certain embodiments, the processor(s) 1305 accomplish this by executing software or firmware stored in memory 1310. The processor(s) 1305 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1310 is or includes the main memory of the computer system 1100. The memory 1310 represents any form of random access memory (RAM), read-only memory (ROM), flash memory (as discussed above), or the like, or a combination of such devices. In use, the memory 1310 may contain, among other things, a set of machine instructions which, when executed by processor 1305, causes the processor 1305 to perform operations to implement embodiments of the present invention.

Also connected to the processor(s) 1305 through the interconnect 1325 is a network adapter 1315. The network adapter 1315 provides the computer system 1300 with the ability to communicate with remote devices, such as the storage clients, and/or other storage servers, and may be, for example, an Ethernet adapter or Fiber Channel adapter.

The algorithms and software presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from other portions of this description. In addition, the present invention is not described with reference to any particular programming language, and various embodiments may thus be implemented using a variety of programming languages.

The systems corresponding to the methods explained above and associated embodiments relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

We claim:

1. A computer implemented method to enable a user to invite contacts to an event, the computer implemented method comprising:
providing an invitation link in a first forum, wherein the user clicks on the invitation link to share an event related to the first forum with a plurality of select contacts;
providing to the user a plurality of online social networks in response to the user clicking on the invitation link;
providing access to the user to a set of networks from the plurality of networks in response to the user providing authentication information corresponding to the set of networks;
generating an aggregated list of contacts based on contact information retrieved from each of the set of networks;
eliminating duplicate contacts in the aggregated list of contacts;
displaying the aggregated list of contacts to the user within the first forum;
collecting the plurality of select contacts based on contacts selected by the user from the aggregated list of contacts; and
transmitting a message to the plurality of select contacts to share the event related to the first forum with the plurality of select contacts.

2. A computer implemented method to enable a user to invite contacts to an event, the computer implemented method comprising:
providing a first connection link, wherein the user clicks on the first connection link to share an event related to a first forum;
providing to the user a plurality of networks in response to the user selecting the first connection link;
providing access to the user to a set of networks from the plurality of networks in response to the user providing authentication information corresponding to the set of networks;
displaying a centralized list of contacts based on contact information collected from each of the set of networks;
collecting a plurality of selected contacts based on contacts selected by the user from the centralized list of contacts; and
transmitting a message to the plurality of selected contacts to invite the plurality of selected contacts to an event corresponding to the first forum.

3. A computer implemented method to enable a user to invite contacts to an event as recited in claim 2, wherein the first connection link is located within the first forum.

4. A computer implemented method to enable a user to invite contacts to an event as recited in claim 2, wherein the first connection link is located in a toolbar or a bookmark of a browser application, wherein the browser application displays the first forum.

5. A computer implemented method to enable a user to invite contacts to an event as recited in claim 2, the method further comprising:
creating a user specific event page based on the invitation transmitted by the user.

6. A computer implemented method to enable a user to invite contacts to an event as recited in claim 5, the method further comprising:
displaying a confirmation page subsequent to transmitting the message to the plurality of selected contacts, wherein the confirmation page includes a link to the user specific event page.

7. A computer implemented method to enable a user to invite contacts to an event as recited in claim 6, wherein the user specific event page includes a list of the plurality of selected contacts.

8. A computer implemented method to enable a user to invite contacts to an event as recited in claim 7, wherein the user specific event page includes a response indicated by the plurality of selected contacts.

9. A computer implemented method to enable a user to invite contacts to an event as recited in claim 6, wherein the user specific event page includes information about the event and the first forum.

10. A computer implemented method to enable a user to invite contacts to an event as recited in claim 6, wherein the user specific event page includes information pertinent to the event, further wherein the pertinent information includes at least one of:
links to purchase tickets related to the event;
advertisements related to the event; or
information related to a location of the event.

11. A computer implemented method to enable a user to invite contacts to an event as recited in claim 6, wherein the user specific event page includes a discussion board to enable the user and the plurality of selected contacts to post discussion topics.

12. A computer implemented method to enable a user to invite contacts to an event as recited in claim 8, wherein the plurality of selected contacts are allowed to change their response in the user specific event page.

13. A computer implemented method to enable a user to invite contacts to an event as recited in claim 6, wherein the confirmation page includes information pertinent to the event, further wherein the pertinent information includes at least one of:
links to purchase tickets related to the event;
advertisements related to the event; or
information related to a location of the event.

14. A computer implemented method to enable a user to invite contacts to an event as recited in claim 6, wherein each of the plurality of networks includes a social networking website.

15. A computer implemented method to enable a user to invite contacts to an event as recited in claim 6, wherein each of the plurality of networks includes a communication enabling website.

16. A computer implemented method to enable a user to invite contacts to an event as recited in claim 4, wherein the centralized list of contacts includes aggregated contact information from the plurality of networks.

17. A computer implemented method to enable a user to invite contacts to an event as recited in claim 16, further comprising:
eliminating duplicate contacts in the centralized list of contacts.

18. A computer implemented method to enable a user to invite contacts to an event as recited in claim 17, further comprising:
mapping each contact from the centralized list of contacts to identify the duplicate contacts.

19. A computer implemented method to enable a user to invite contacts to an event as recited in claim 2, wherein, when a particular contact appears in more than one network of the plurality of networks:
determining a specific network of the plurality of networks the particular contact most frequently uses.

20. A computer implemented method to enable a user to invite contacts to an event as recited in claim 19, wherein the message is transmitted to the particular contact using the specific network.

21. A computer implemented method to enable a user to invite contacts to an event as recited in claim 2, wherein the centralized list of contacts is provided to the user as an embedded section in the first forum.

22. A computer implemented method to enable a user to invite contacts to an event as recited in claim 2, wherein the centralized list of contacts is provided to the user as a hovering section over the first forum.

23. A computer implemented method to enable a user to invite contacts to an event as recited in claim 2, wherein the centralized list of contacts is provided to the user as a separate window outside of the first forum.

24. A computer implemented method to enable a user to invite contacts to an event as recited in claim 2, wherein information related to the user specific event page is conveyed to an organizer of the event.

25. A computer implemented method to provide to a user a centralized contact list, the computer implemented method comprising:
providing a first connection link in a first forum;
providing to the user links to a plurality of networks in response to the user selecting the first connection link;
providing access to the user to a one or more networks from the plurality of networks in response to the user providing authentication information corresponding to the one or more networks;
aggregating a centralized contact list based on contact information collected from the one or more networks that the user has verified access to; and
displaying the centralized list of contacts to the user, wherein the user subsequently transmits a message related to the first forum to a plurality of selected contacts from the centralized list of contacts.

26. A computer implemented method to enable a user to invite contacts to an event as recited in claim 25, the method further comprising:
creating a user specific landing page based on the message transmitted by the user.

27. A computer implemented method to enable a user to invite contacts to an event as recited in claim 26, the method further comprising:
displaying a confirmation page subsequent to transmitting the message to the plurality of selected contacts, wherein the confirmation page includes a link to the user specific landing page.

28. A computer implemented method to enable a user to invite contacts to an event as recited in claim 27, wherein the user specific landing page includes a list of the plurality of selected contacts.

29. A computer implemented method to enable a user to invite contacts to an event as recited in claim 28, wherein the user specific landing page includes a response indicated by the plurality of selected contacts.

30. A computer implemented method to enable a user to invite contacts to an event as recited in claim 27, wherein the user specific landing page includes a discussion board to enable the user and the plurality of selected contacts to post discussion topics.

31. A computer implemented method to enable a user to invite contacts to an event as recited in claim 30, further comprising:
eliminating duplicate contacts in the centralized list of contacts.

32. A computer implemented method to enable a user to invite contacts to an event as recited in claim 31, further comprising:
mapping each contact from the centralized list of contacts within the plurality of networks to identify the duplicate contacts.

33. A computer implemented method to enable a user to invite contacts to an event as recited in claim 25, wherein, when a particular contact appears in more than one network of the plurality of networks:
determining a specific network of the plurality of networks the particular contact most frequently uses.

34. A computer implemented method to enable a user to invite contacts to an event as recited in claim 33, wherein the message is transmitted to the particular contact using the specific network.

35. A computer implemented system to enable a user to invite contacts to an event, the computer implemented system comprising:
a processor to execute a set of instructions corresponding to a plurality of modules, the plurality of modules including:
a selection module configured to provide the user a link to a plurality of networks in response to the user selecting a first connection link from a first forum;
an authentication module configured to provide access to the user to a set of networks from the plurality of networks in response to the user providing authentication information to login to the set of networks;
a listing module configure to display a centralized list of contacts based on contact information collected from each of the set of networks;
a collection module configured to collect a plurality of selected contacts based on contacts selected by the user from the centralized list of contacts; and
a transmission module configured to transmit a message to the plurality of selected contacts to invite the plurality of selected contacts to an event corresponding to the first forum; and
a memory to store the set of instructions corresponding to the plurality of modules.

36. A computer implemented system to enable a user to invite contacts to an event as recited in claim 35, wherein the plurality of modules further comprises:
a response module to display a confirmation page subsequent to the transmission module transmitting the message, wherein the response module includes a link to a user specific event page.

37. A computer implemented system to enable a user to invite contacts to an event as recited in claim 36, wherein the user specific event page includes information about the event and the first forum.

38. A computer implemented system to enable a user to invite contacts to an event as recited in claim 35, wherein the plurality of modules further comprises:
a discussion board module configured to enable the user and the plurality of selected contacts to post discussion topics in the user specific event page.

39. A computer implemented system to enable a user to invite contacts to an event as recited in claim 35, wherein the plurality of modules further comprises:
a duplicate elimination module configured to map the centralized list of contacts among the plurality of networks to eliminate duplicate contacts from the centralized list of contacts.
